(19) United States
(12) Patent Application Publication
(10) Pub. No.: US 2024/0064013 A1
(43) Pub. Date: Feb. 22, 2024

(54) SECURE CRYPTOGRAPHIC KEY MANAGEMENT

(71) Applicant: Royal Bank of Canada, Toronto (CA)

(72) Inventors: Ian Gerics, Toronto (CA); Mike J. Weber, Oakville (CA)

(21) Appl. No.: 18/116,502

(22) Filed: Mar. 2, 2023

Related U.S. Application Data
(60) Provisional application No. 63/398,995, filed on Aug. 18, 2022.

(51) Int. Cl. H04L 9/08

(52) U.S. Cl. CPC H04L 9/0894; H04L 9/088

(57) ABSTRACT

A method of making cryptographic key metadata available to key owners while protecting the integrity of the cryptographic key metadata comprises extracting key metadata from a metadata storage on a key data storage system. The metadata storage is logically isolated from a sensitive cryptographic data storage on the key data storage system. The method further comprises transmitting, by unidirectional communication, the extracted key metadata to a user-accessible metadata database that is separate and distinct from the metadata storage on the key data storage system. The method identifies, from the user-accessible metadata database, user-specific metadata for at least one cryptographic key associated with an authorized user associated with the at least one cryptographic key, and communicates the identified user-specific metadata to the authorized user.

### CROSS-REFERENCE TO RELATED APPLICATION

This application claims priority to U.S. Provisional Patent Application No. 63/398,995 filed on Aug. 18, 2022, the teachings of which are hereby incorporated by reference.

### TECHNICAL FIELD

The present disclosure relates to cryptographic keys, and more particularly to secure management of cryptographic keys.

### BACKGROUND

In symmetric key cryptography, which is typically used to protect data at rest, keys are encrypted with other keys, and a single encryption key is used for data encryption and data decryption. The data may be encrypted during storage and decrypted during authorized access. A data encryption key (DEK) is used for encryption and decryption of the data, and a key encryption key (KEK) is used to encrypt and decrypt the DEK. A key management system (KMS) is a computer (typically a server computer) executing key management software, and which includes or interfaces with specialized cryptographic hardware to generate the cryptographic keys and associated metadata.

Cryptographic keys used by an institution can be maintained in a secure key data storage system (typically a server computer), which can store sensitive data (most importantly the cryptographic keys themselves and also the metadata about the cryptographic keys). In order to provide adequate security protections, access to these secure key data storage systems is severely limited, with only a small group of dedicated key management personnel being given access.

While these access limitations provide valuable protections, they also inhibit administrative management relating to the cryptographic keys. Many organizations maintain periodic (e.g. yearly) attestation requirements to ensure that cryptographic key owners within the organization are aware of their cryptographic keys and their responsibilities related to these cryptographic keys. Note that the term “attestation” as used in this document refers to administrative attestation pursuant to an organization's rules, and not to cryptographic attestation. The cryptographic key owners are usually different from the dedicated key management personnel and thus lack access to the secure key data storage system(s), complicating the attestation process. Additionally, good security practice provides for cryptographic keys to be expired and replaced, and the lack of access to the secure key data storage system(s) make it more difficult for the cryptographic key owners to be aware of looming expiries and take action to avoid outages.

Previous approaches to managing attestation and expiry for cryptographic key owners have been unwieldy and largely manual, such as exchanging electronic word processing documents and/or e-mails.

### SUMMARY OF THE INVENTION

The present disclosure describes systems, methods and computer program products that allow cryptographic key owners to access a store of metadata about their cryptographic keys that is located outside of the key data storage system. This gives the cryptographic key owners better visibility on their cryptographic keys without compromising security by interposing a layer of isolation between the user-accessible metadata and the key data storage system, which in turn imposes a further level of isolation between the user-accessible metadata and the physical host of the key management system that generates the cryptographic keys.

In one aspect, a method of making cryptographic key metadata available to key owners while protecting integrity of the cryptographic key metadata is described. The method comprises extracting key metadata from a metadata storage on a key data storage system, wherein the metadata storage is logically isolated from a sensitive cryptographic data storage on the key data storage system, transmitting, by unidirectional communication, the extracted key metadata to a user-accessible metadata database, identifying, from the user-accessible metadata database, user-specific metadata for at least one cryptographic key associated with an authorized user associated with the cryptographic key(s), and communicating the identified user-specific metadata to the authorized user.

In an embodiment, identifying the user-specific metadata for the cryptographic key(s) comprises proactively identifying an impending expiry of the cryptographic key(s), and communicating the identified user-specific metadata to the authorized user comprises proactively communicating the impending expiry to the authorized user. In a particular embodiment, proactively identifying the impending expiry of the cryptographic key(s) is carried out at pre-specified intervals.

In an embodiment, identifying the metadata for the cryptographic key(s) comprises receiving, from a requesting user, a query against the user-accessible metadata database, obtaining an identity of the requesting user, testing the identity of the requesting user against access requested by the query, responsive to determining that the requesting user is an authorized user in respect of the access requested by the query, executing the query against the user-accessible database to obtain query results, and communicating the identified user-specific metadata to the authorized user comprises returning the query results to the requesting user, wherein, responsive to determining that the requesting user lacks authorization for the access requested by the query, execution of the query is declined. In particular embodiments, the authorized user is one of an individual key owner and a key services administrator.

In an embodiment, identifying the user-specific metadata for the cryptographic key(s) comprises proactively identifying an attestation requirement for the cryptographic key(s), and communicating the identified user-specific metadata to the authorized user comprises proactively communicating the attestation requirement to the authorized user.

In an embodiment, the method further comprises receiving from a requesting user an update against the user-accessible metadata database, obtaining an identity of the requesting user and testing the identity of the requesting user against access requested by the update, responsive to determining that the requesting user is an authorized user in respect of the access requested by the update, executing the update against the user-accessible metadata database, and responsive to determining that the requesting user lacks authorization for the access requested by the update, declining to execute the update. In particular embodiments, the update is a request to transfer key ownership of a specific cryptographic key from a current key owner to a prospective new key owner, the requesting user is the current key owner of the specific cryptographic key, and executing the update against the user-accessible metadata database comprises requesting an acceptance of the key ownership of the specific cryptographic key from the prospective new owner, and responsive to receiving the acceptance of the key ownership of the specific cryptographic key from the prospective new owner, in the user-accessible metadata database, delisting the requesting user as the current key owner and listing the prospective key owner as the current key owner.

In another aspect, the present disclosure is directed to a computer system comprising at least one processor and memory coupled to the at least one processor, the memory containing instructions which, when executed by the at least one processor, cause the at least one processor to implement the method as described above.

In a further aspect, the present disclosure is directed to at least one tangible, non-transitory computer-readable media containing instructions which, when executed by at least one processor of a computer system, cause the at least one processor to implement the method as described above.

### BRIEF DESCRIPTION OF THE DRAWINGS

These and other features will become more apparent from the following description in which reference is made to the appended drawings wherein:

FIG. 1 is a block diagram showing an illustrative cryptographic key management arrangement according to an aspect of the present disclosure;

FIG. 2 is an illustrative entity relationship diagram for a user-accessible metadata database according to an aspect of the present disclosure;

FIG. 3 is a flow chart showing an illustrative method of making cryptographic key metadata available to key owners while protecting the integrity of the cryptographic key metadata, according to an aspect of the present disclosure;

FIG. 4 is a flow chart showing an illustrative method for handling a query against a user-accessible metadata database, according to an aspect of the present disclosure;

FIG. 5 is a flow chart showing an illustrative method for executing an update against a user-accessible metadata database, according to an aspect of the present disclosure; and

FIG. 6 is a block diagram showing an illustrative computer system in respect of which aspects of the present technology may be implemented.

### DETAILED DESCRIPTION

According to one aspect of the present disclosure, cryptographic key owners can be given access to a web portal providing a web-based view of the metadata for their cryptographic keys stored in the key data storage system; this portal can also be used to facilitate attestations and provide notice of impending expiry of cryptographic keys. The store of metadata accessed via the web portal is located outside of the key data storage system.

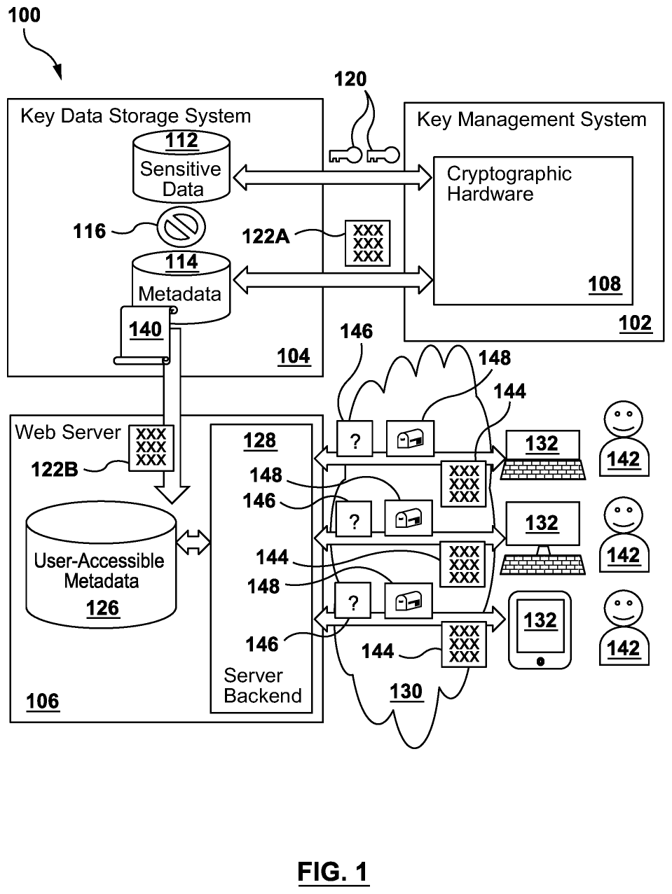

Reference is now made to FIG. 1, which is a block diagram showing an illustrative cryptographic key management arrangement according to an aspect of the present disclosure, denoted generally by reference 100.

They key management arrangement 100 comprises a key management system 102, a key data storage system 104 and a web server 106, each of which may comprise one or more computers (e.g. a single server computer or a server rack). In the embodiment shown in FIG. 1, the key data storage system 104 and the web server 106 are separate and distinct computer systems that are communicatively coupled to one another, for example via a network (e.g. intranet or the Internet). In still other embodiments, the key data storage system and the web server may be implemented on a single computer system with appropriate logical separation. While only a single key management system 102 is shown for simplicity of illustration, some embodiments may employ multiple key management systems.

The key management system 102 implements suitable key management software for generating cryptographic keys and associated metadata. In one embodiment, the key management system 102 implements the IBM® Enterprise Key Management Foundation (EKMF) software offered by International Business Machines Corporation having an address at New Orchard Road, Armonk, New York 10504 although other suitable software may also be used. For example, and without limitation, the key management system 102 may implement the CipherTrust® Enterprise Key Management software offered by Thales UK Limited, having an address at 350 Longwater Avenue, Green Park, Reading, Berkshire, UK RG26GF, the AWS® Key Management Service software offered by Amazon Technologies, Inc. having an address at 410 Terry Ave N, Seattle, WA, 98109 or the Oracle® Cloud Infrastructure Vault software offered by Oracle International Corporation having an address at 500 Oracle Parkway, Redwood City, CA 94065.

The key management system 102 includes specialized cryptographic hardware 108 for generating the cryptographic keys and associated metadata. Examples of suitable cryptographic hardware include IBM® PCIe Cryptographic Coprocessors such as the IBM® 4767 Crypto Card, which is available as IBM Z® feature CEXSS, IBM Power Systems™ features EJ32 and EJ33, and x64 MTM 4767-002. This is merely one illustrative example of cryptographic hardware and is not intended to be limiting.

The key management system 102 communicates with the key data storage system 104. In the embodiment shown in FIG. 1, the key management system 102 is a physically separate host (server system) from the key data storage system 104. The key data storage system 104 includes a sensitive cryptographic data storage 112 and a metadata storage 114. Of note, the metadata storage 114 is logically isolated 116 from the sensitive cryptographic data storage 112 within the key data storage system 104; that is, while both the metadata storage 114 and the sensitive cryptographic data storage 112 can communicate with the cryptographic hardware 108, they cannot communicate with one another, whether directly or indirectly, through appropriate logical controls. Preferably, the key data storage system 104 is configured so that the web server 106 cannot write to the to the metadata storage 114 or to the sensitive cryptographic data storage 112. Thus, communication between the key data storage system 104 and the web server 106 is unidirectional; information from the key data storage system 104 can be written to the web server 106, but information from the web server 106 cannot be written to the key data storage system 104.

The cryptographic hardware 108, under the control of the key management software, transmits cryptographic keys 120 to the sensitive cryptographic data storage 112 and transmits key metadata 122A about the cryptographic keys 120 to the metadata storage 114. In one embodiment, the metadata 122A contains information from the key creation process in the cryptographic hardware 108. Thus, the key management system 102 populates the metadata storage 114 and the sensitive cryptographic data storage 112.

The web server 106 hosts a user-accessible metadata database 126 and a server backend 128 which are communicatively coupled such that the server backend 128 can submit queries to, retrieve data from, and update the user-accessible metadata database 126. Although shown as part of the web server 106 for simplicity of illustration, the user-accessible metadata database 126 may be hosted on a separate database server system that is communicatively coupled to the web server 106. Of note, the user-accessible metadata database 126 is separate and distinct from the metadata storage 114 on the key data storage system 104.

The server backend 128 communicates through one or more networks 130, for example an intranet or the Internet, with a plurality of computing devices 132, which may include a laptop computer, a desktop computer, and a tablet computer or smartphone. In one illustrative non-limiting embodiment, the server backend 128 is a UNIX-based application built in Python's Django web framework and deployed on an Apache server which handles remote connections; other configurations are also contemplated.

A script 140 executing on the key data storage system 104 extracts key metadata from the metadata storage 114 on the key data storage system 104 and transmits copies 122B of the extracted key metadata 122A to the separate user-accessible metadata database 126, which stores the copies 122B of the extracted key metadata 122A and preferably also stores additional metadata, for example metadata about attestations. The user-accessible metadata database 126 may, for example, be implemented using the SQLite C-language library.

Some illustrative pseudocode which represents functions of the script 140 is provided below, with the symbol “#” denoting a comment to provide additional context; the pseudocode also lists the metadata fields being extracted for reference.

```
# (+1) = next generation of file
# (0) = most recent generation of file
metadata_fields = [name, type, len, algorithm, key_check_value,
                description, app_code, location, conveyance,
                creation_date, expiry_date, status]
while(time=(day,time)):
  # Pull data for metadata storage
  select * from metadata_storage = key_list
  for i in key_list:
      write i to unformatted_file(+1)
    # Format metadata
    for key in unformatted_file:
      write key[metadata_fields] to formatted_file(+1)
    # Send to webserver
      send formatted_file(0) to web_server
# Receive and add to CAM
while(time=(day,time)):
    for key in formatted_file:
      if key not in metadata_database:
              insert_record(key) into metadata_database
      else:
              update_record(key) into metadata_database
```

Where the key data storage system 104 runs on a z/OS® server system, the script 140 may be implemented using job control language (JCL) and the C-programming language. Other implementations may be used for other types of server systems; such implementation is within the capability of one of ordinary skill in the art, now informed by the present disclosure.

The script 140 transmits copies 122B of the extracted key metadata 122A to the user-accessible metadata database 126 by unidirectional communication; that is, the key data storage system 104 and the web server 106 are configured so that information can be transmitted from the metadata storage 114 on the key data storage system 104 to the user-accessible metadata database 126 on the web server 106, but the metadata storage 114 on the key data storage system 104 cannot receive any information from the user-accessible metadata database 126 on the web server 106. In one embodiment, unidirectional communication may be implemented through use of suitably configured Universal Command (UCMD) software. One non-limiting illustrative example of UCMD software is the Managed File Transfer (MFT) software offered by Stonebranch, Inc. having an address at 4550 North Point Parkway, Suite 200, Alpharetta, GA, 30022 USA; this is merely one illustrative example.

An authorized user 142 of one or more of the cryptographic keys 120 may use one of the computing devices 132 to communicate with the server backend 128 through the network(s) 130 in relation to the cryptographic keys 120 associated with that authorized user. This may be implemented, for example, via a web interface (e.g. web portal implemented in HTML), preferably with a user name and a hashed and salted password test using an active directory for authentication. Additional security verification options include checking the IP address of the requesting user, and multi-factor authentication. The server backend 128 may identify, from the user-accessible metadata database 126, user-specific metadata 144 for at least one of the cryptographic keys 120 associated with that authorized user 142. The server backend 128 may then communicate the identified user-specific metadata 144 to the authorized user 142 via the network(s) 130 and the respective computing device 132. Thus, the server backend 128 enables a web portal that provides authorized users 142 with access to the cryptographic key metadata, but via a copy thereof without giving the authorized users 142 any access to the metadata storage 114 on the key data storage system 104.

In some embodiments, the server backend 128 may proactively identify an impending expiry of the cryptographic key(s) 120 associated with the authorized user 142 and proactively communicate the impending expiry to the authorized user 142; the impending expiry of a particular cryptographic key 120 is thus one non-limiting example of user-specific metadata 144. For example, the user-accessible metadata database 126 may store the expiry information and the server backend 128 may run a periodic expiry query (e.g. via a script) against the user-accessible metadata database 126. In some embodiments, proactively identifying the impending expiry of the cryptographic key(s) 120 is carried out at pre-specified intervals. Non-limiting examples of such intervals include 90 days, 60 days, and 30 days. Alternatively, the user-accessible metadata database 126 may implement a “tickler” system to police impending expiry deadlines. The impending expiry may be proactively communicated to the authorized user 142 by, for example, e-mail message, SMS/text message (including proprietary formats such as iMessage), and pop-up window, among others. Optionally, an authorized user 142 may be provided with the option to display an HTML page that shows the expiry dates for the cryptographic key(s) 120 associated with that authorized user 142. Thus, the server backend 128 enables cryptographic key expiry notifications to be provided for the cryptographic key owners to action their keys accordingly. Optionally, an authorized user can configure the timing of the expiry notifications. In addition to impending expiry, other notifications may be provided to the authorized users 142, such as to every authorized user 142 or to a subset of authorized users 142. The subset of authorized users 142 may be those authorized users 142 whose computing devices 132 have communicate with the server backend 128 during a predetermined prior period. For example, and without limitation, in some embodiments those authorized users 142 whose computing devices 132 have communicate with the server backend 128 during the preceding year may receive notifications. The notifications may include notice of an impending planned maintenance outage, among other types of notification. Such notifications may be sent by, for example, e-mail message, SMS/text message (including proprietary formats such as iMessage), and pop-up window, among others.

In some embodiments, the server backend 128 may proactively identify an attestation requirement for the cryptographic key(s) 120 associated with the authorized user 142 and proactively communicate the attestation requirement to the authorized user 142 through the network(s) 130 and computing device 132; the attestation requirement for a particular cryptographic key 120 is thus another non-limiting example of user-specific metadata 144. Attestation may be represented as an object within the user-accessible metadata database 126 and associated with a particular authorized user 142, and the server backend 128 may query whether an attestation lists all cryptographic keys 120 associated with that authorized user 142. Any identified attestation requirement may be proactively communicated to the authorized user 142 by, for example, e-mail message, SMS/text message (including proprietary formats such as iMessage), and pop-up window, among others, and/or an authorized user 142 may be provided with the option to display an HTML page that shows the attestation requirement(s) for the cryptographic key(s) 120 associated with that authorized user 142. Thus, the server backend 128 partially automates the periodic (e.g. annual) attestations through a web-based portal.

In some embodiments, the server backend 128 may receive, from a requesting user, a query 146 against the user-accessible metadata database 126. The server backend 128 will obtain the identity of the requesting user; where a user name and password are used, the identity of the requesting user will be received with the query by way of the POST request as the login provides the identity of the requesting user. The server backend 128 then tests the identity of the requesting user against the access requested by the query 146 to determine whether the requesting user is an authorized user 142 in respect of the access requested by the query. Where a user name and password are used, the test may comprise checking whether the requesting user is either an individual key owner or a key services administrator for the cryptographic key(s) 120 associated with the query 146. Thus, in some embodiments, an authorized user 142 may be either an individual key owner or a key services administrator. The key owner is the individual human being who has organizational responsibility for the lifecycle of the cryptographic key, including creation, usage, and destruction, and may delegate some usage responsibilities to others. A key services administrator is an individual human being who administers the server backend 128, controls access to the portal, and attends to actual implementation of the lifecycle of the cryptographic keys at the request of the respective key owners. Where the server backend 128 determines that the requesting user is an authorized user 142 in respect of the access requested by the query 146, the server backend 128 executes the query 146 to obtain query results, and returns the query results to the authorized user 142 (who is also the requesting user), for example as an HTML page. Thus, the query results are another non-limiting example of user-specific metadata 144. If the server backend 128 determines that the requesting user lacks authorization for the access requested by the query 146, execution of the query 146 is declined.

In some embodiments, the server backend 128 may receive, from a requesting user via one of the computing devices 132, an update 148 against the user-accessible metadata database 126. An update 148 may be, for example, addition of an attestation, a change to a description associated with one of the cryptographic keys 120, or setting one or more notification periods for expiry. As described above, this may be implemented via a web interface with a user name and password test and optionally additional verification. The to server backend 128 will obtain the identity of the requesting user and test the identity of the requesting user against the access requested by the update 148 to determine whether the requesting user is an authorized user 142 (e.g. an individual key owner or a key services administrator) in respect of the access requested by the update 148. Where the server backend 128 determines that the requesting user is an authorized user 142 in respect of the access requested by the update 148, the server backend 128 executes the update 148 against the user-accessible metadata database 126. Of note, because of the unidirectional communication, execution of the update 148 against the user-accessible metadata database 126 does not affect any metadata in the metadata storage 114. Where the server backend 128 determines that the requesting user lacks authorization for the access requested by the update 148, the server backend 128 declines to execute the update 148.

In some particular embodiments, the update 148 may be a request to transfer key ownership of a specific cryptographic key 120 from a current key owner to a prospective new key owner. In such an embodiment, the requesting user is the current key owner of the specific cryptographic key 120, and the server backend 128 executes the update 148 against the user-accessible metadata database 126 by requesting an acceptance of the key ownership of the specific cryptographic key 120 from the prospective new owner. This may be done, for example, by an e-mail or text message containing a link to an HTML, portal for the server backend 128. Once the server backend 128 receives the acceptance of the key ownership of the specific cryptographic key 120 from the prospective new owner, the server backend 128 will update the user-accessible metadata database 126 by delisting the requesting user as the current key owner and listing the prospective key owner as the current key owner.

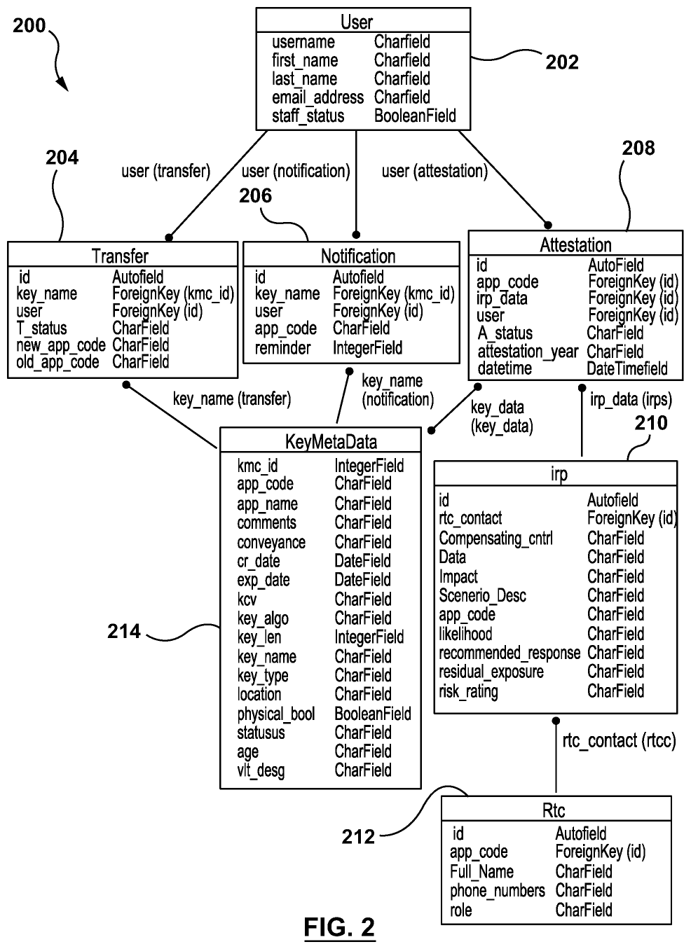

Reference is now made to FIG. 2, in which shows an illustrative entity relationship diagram 200 for an illustrative, non-limiting implementation of a user-accessible metadata database (e.g. user-accessible metadata database 126 in FIG. 1) according to an aspect of the present disclosure. As can be seen, there is a user entity 202, a transfer entity 204, a notification entity 206, an attestation entity 208, an incident response plan (IRP) entity 210, a response team contact (RTC) entity 212, and a key metadata entity 214. In each of the entities, where the “app_code” field (or a similar field) appears it may be used to identify a business unit within an organization to which a cryptographic key relates. The “app_code” fields are optional and are generally not discussed further.

The user entity 202 is used to hold information about each cryptographic key owner, and contains fields for username, first name, last name, e-mail address and staff status.

The transfer entity 204 may be used when one cryptographic key owner wishes to transfer a particular cryptographic key to a new cryptographic key owner; the transfer entity 204 stores the transfer information until the new cryptographic key owner accepts. The transfer entity 204 contains fields for ID (a unique identifier for the transfer), key name (identifying the cryptographic key being transferred), user (the current cryptographic key owner who initiates the transfer), and transfer status, denoted by “T_status”, which may be “pending” or “complete”. The key name and user fields are used as foreign keys. Fields for “new_app_code” and “old_app_code” are also provided where an app code is used.

The notification entity 206 is used to store the reminder notice period for proactively identifying the impending expiry of a particular cryptographic key and contains fields for ID (a unique identifier), key name (identifying the cryptographic key to which the notice relates), user (the current cryptographic key owner), and reminder (the notice period). The key name and user fields are used as foreign keys. An “app_code” filed is also provided where an app code is used.

The attestation entity 208 stores information linking specific cryptographic keys to an incident response plan (IRP) for a given period (e.g. one year) and therefore the attestation entity 208 is linked to the incident response plan (IRP) entity 210. In addition to a field for ID (a unique identifier) and an “app_code” field where an app code is used), the attestation entity 208 contains an “irp data” field linking to the relevant instance of the incident response plan (IRP) entity 210, a user field and an “A status” field for the status of the attestation, which may be “pending” or “complete”, for example (e.g. the cryptographic key owner may submit the attestation, creating an instance of the attestation entity 208 (“pending”), and a key services administrator can then approve the attestation (“complete”)). An attestation year field stores the year (or other period) to which the attestation relates, and the “datetime” field stores a timestamp for creation of the instance. The “irp_data” field and user field are used as foreign keys.

An incident response plan is the procedure to be deployed or implemented in the event that a cryptographic key were to be compromised, and is represented by the incident response plan (IRP) entity 210, which has an ID field for unique identification. Additional fields include “rtc contact” for the contact person on the response team (and which serves as a foreign key), “Compensating cntrl” to identify procedures to minimize the probability or magnitude of the impact of a compromise of a cryptographic key, “Data” representing the data at risk from a compromise of a cryptographic key, and “Impact” representing the impact of a worst case scenario from a compromise of a cryptographic key. Other fields include “Scenario Desc” to describe the compromise scenario that could introduce the risk, “likelihood” (a ranking, e.g. low/remote to high/certain) of the risk materializing given the compensating controls, “recommended_response” in the event of a compromise, “residual exposure” expected given the impact and likelihood of the risk, which may be a ranking, e.g. “low”, “medium” or “high”, and “risk_rating” (e.g. 1-low to 5-high) representing the impact if the risk materializes, assuming no compensating controls.

The RTC entity 212 has an ID field, an “app_code” field serving as a foreign key, a “Full_Name” field, “phone_numbers” field and “role” field.

The key metadata entity 214 stores metadata about cryptographic keys, and has a “kmc_id” field which stores a unique identifier. The “app_name” field can be used to store a human-comprehensible name for the app code (where an app code is used), and the “comments” field, as the name implies, stores any relevant comments. The conveyance field identifies whether the cryptographic key is internal to the organization or has been conveyed to an external third party, and the “cr_date” and “exp_date” fields store, respectively, the creation date and the expiration date of the cryptographic key. The “kcv” field stores a key check value (checksum), the “key_algo” field is used to identify the algorithm used by the cryptographic key, the “key_len” field stores the length of the key (in bits), the “key_name” field stores the name of the cryptographic key and the “key_type” field represents the function of the cryptographic key (for example, whether it is used for encryption or digital signatures). The location field identifies whether the cryptographic key is used in a development/test environment or in a production environment. The “physical bool” field is a Boolean value used to indicate whether the cryptographic key has a physical component or is digital only, the status field indicates the stage of the lifecycle of the cryptographic key (e.g. active or destroyed—stage of lifecycle), the usage field may allow a user to add notes about how the cryptographic key is used and the “vlt_desg” field indicates, for a key having a physical component, the location of the physical vault wherein that physical component is stored.

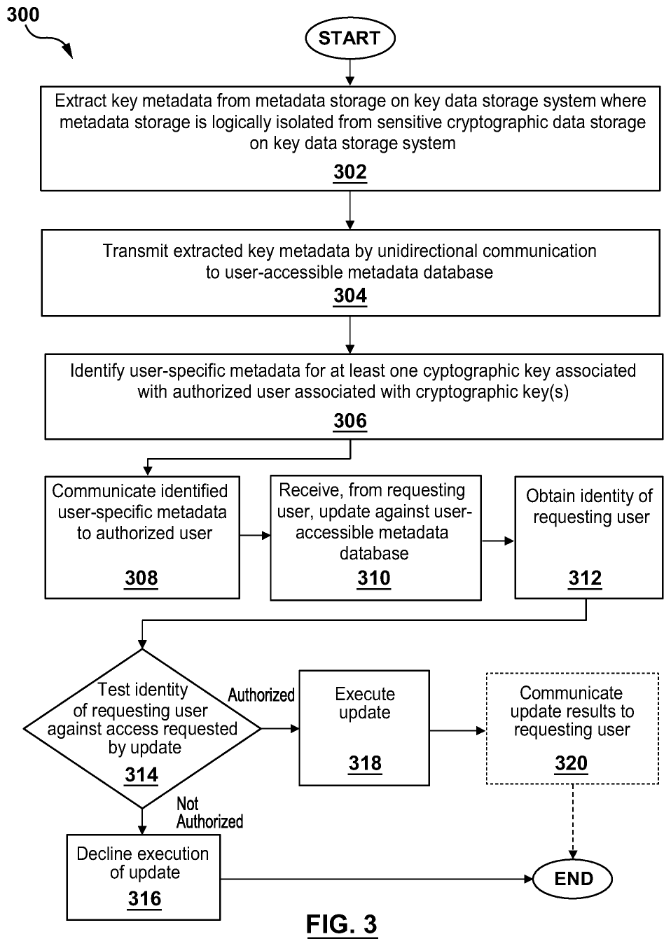

Reference is now made to FIG. 3, which is a flow chart showing an illustrative method of making cryptographic key metadata available to key owners while protecting the integrity of the cryptographic key metadata. At step 302, the method 300 extracts key metadata from a metadata storage on a key data storage system on which the metadata storage is logically isolated from a sensitive cryptographic data storage on the key data storage system. At step 304, the method 300 transmits the extracted key metadata by unidirectional communication to a user-accessible metadata database, which is separate and distinct from the metadata storage on the key data storage system. At step 306, the method 300 identifies user-specific metadata for at least one cryptographic key associated with an authorized user associated with the at least one cryptographic key, and at step 308 the method 300 communicates the identified user-specific metadata to the authorized user.

In one embodiment, identifying the user-specific metadata for the at least one key at step 306 comprises proactively identifying an impending expiry of the at least one cryptographic key (which may be done at specified intervals) and communicating the identified user-specific metadata to the authorized user at step 308 comprises proactively communicating the impending expiry to the authorized user. In another embodiment, identifying the metadata for the at least one cryptographic key at step 306 comprises proactively identifying an attestation requirement for the at least one cryptographic key and communicating the identified metadata to the authorized user at step 308 comprises proactively communicating the attestation requirement to the authorized user.

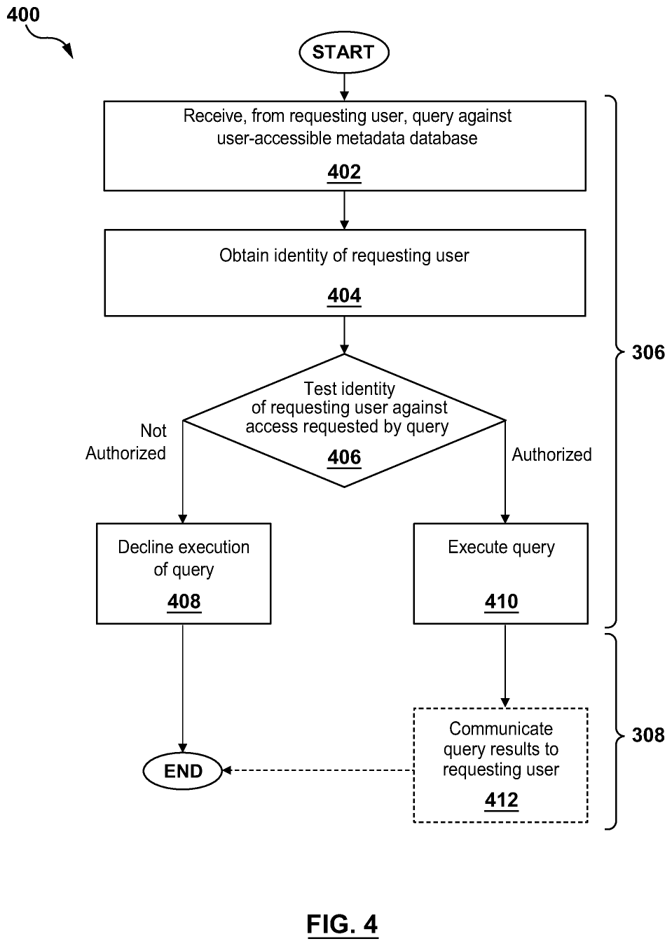

Reference is now made to FIG. 4, which shows a method 400 for handling a query against the user-accessible metadata database. The method 400 represents a first particular illustrative non-limiting implementation of steps 306 and 308 of the method 300 shown in FIG. 3.

At step 402, the method 400 receives, from a requesting user, a query against the user-accessible metadata database, and at step 404 the method 400 obtains an identity of the requesting user, which may be received with the query (e.g. a requesting user may log in to a web portal with a user name and password). At step 406, the method 400 tests the identity of the requesting user against access requested by the query. If the method 400 determines at step 406 that the requesting user lacks authorization for the access requested by the query, the method 400 proceeds to step 408 and execution of the query is declined, optionally with notification to the requesting user. Responsive to determining at step 406 that the requesting user is an authorized user in respect of the access requested by the query (e.g. the requesting user is one of an individual key owner and a key services administrator for the cryptographic key(s) to which the query relates and therefore is an authorized user), the method 400 proceeds to step 410. At step 410, the method 400 executes the query, and then proceeds to step 412 to communicate the query results to the requesting user. In the method 400, steps 402 to 410 correspond to step 306 of the method 300 in FIG. 3 and step 412 corresponds to step 308 of the method 300 in FIG. 3.

Returning now to FIG. 3, at step 310 the method 300 receives, from a requesting user, an update against the user-accessible metadata database. The update may be, for example, a change in key ownership or an attestation. At step 312 the method 300 obtains an identity of the requesting user, which may be received with the update (e.g. a requesting user may log in to a web portal with a user name and password). At step 314, the method 300 tests the identity of the requesting user against access requested by the update. If the method 300 determines at step 314 that the requesting user lacks authorization for the access requested by the update, the method 300 proceeds to step 316 and execution of the update is declined. Responsive to determining at step 314 that the requesting user is an authorized user in respect of the access requested by the update (e.g. the requesting user is one of an individual key owner and a key services administrator and therefore is an authorized user in respect of the cryptographic key(s) to which the update relates), the method 300 proceeds to step 318. At step 318, the method 300 executes the update, and then proceeds to optional step 320 to communicate the update results to the requesting user.

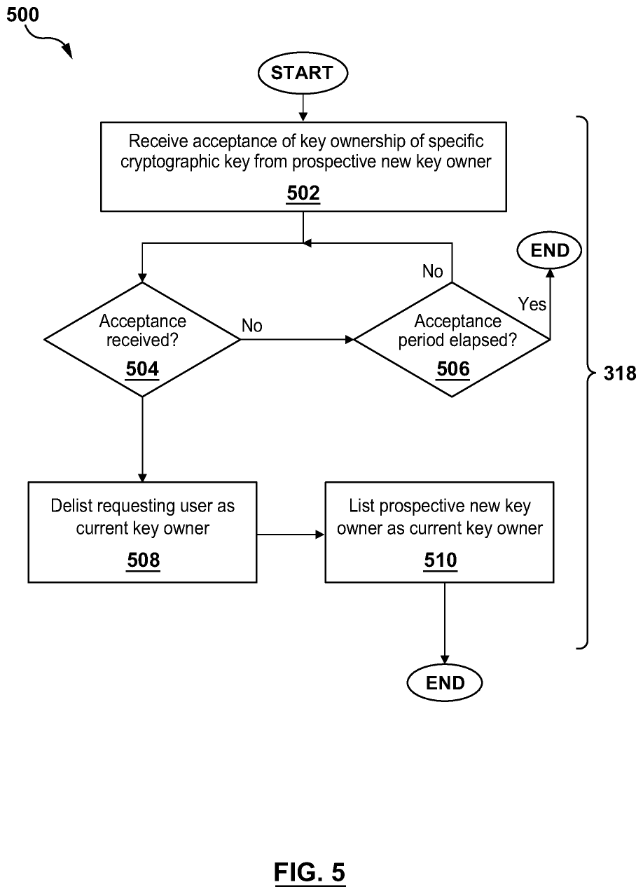

Reference is now made to FIG. 5, which shows a method 500 that is a particular illustrative non-limiting implementation of step 318 (executing the update against the user-accessible metadata database) of the method 300. In this particular implementation, the update is a request to transfer key ownership of a specific cryptographic key from a current key owner to a prospective new key owner, and the requesting user is the current key owner of that specific key cryptographic key. At step 502, the method 500 requests acceptance of the key ownership of the specific cryptographic key from the prospective new key owner, for example by an e-mail notification with a hyperlink. At step 504, the method 500 checks whether the acceptance has been received. If no acceptance has been received from the prospective new key owner (“no” at step 504), the method 500 proceeds to step 506 to check whether an acceptance period has elapsed. If the acceptance period has not elapsed (“no” at step 506), the method 500 returns to step 504 and continues to monitor for an acceptance from the prospective new key owner. However, if the acceptance period has elapsed (“yes” at step 506), the method 500 ends (i.e. the method 500 times out). The acceptance period may be, for example, 24 hours, 48 hours, 72 hours or some other suitable period.

Responsive to receiving the acceptance of the key ownership of the specific key from the prospective new key owner (“yes” at step 504), the method 500 proceeds to step 508 to delist the requesting user as the current key owner then to step 510 to list the prospective new key owner as the current key owner. Steps 508 and 510 may be performed in reverse order or substantially simultaneously.

As can be seen from the above description, the cryptographic key management technology described herein represents significantly more than merely using categories to organize, store and transmit information and organizing information through mathematical correlations. The present disclosure describes an improvement to cryptographic key management technology as it facilitates access to user-specific key metadata for the key owners while allowing the original key metadata in the key data storage system to be isolated from the key owners. This avoids key owners having direct access to the key data storage system, which would violate cryptographic compliance requirements, and reduces the risks of an attacker being able to extract sensitive data such as key values from the key data storage system. As such, the technology described and claimed herein is confined to cryptographic key management applications, and is a specific solution to the computer-related problem of how to provide access to data without compromising the security of that data.

The present technology may be embodied within a system, a method, a computer program product or any combination thereof. The computer program product may include a computer readable storage medium or media having computer readable program instructions thereon for causing a processor to carry out aspects of the present technology. The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing.

A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present technology may be assembler instructions, instruction-set-architecture (ISA) instructions, machine instructions, machine dependent instructions, microcode, firmware instructions, state-setting data, or either source code or object code written in any combination of one or more programming languages, including an object oriented programming language or a conventional procedural programming language. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to implement aspects of the present technology.

Aspects of the present technology have been described above with reference to flowchart illustrations and/or block diagrams of methods, apparatus (systems) and computer program products according to various embodiments. In this regard, the flowchart and block diagrams in the Figures illustrate the architecture, functionality, and operation of possible implementations of systems, methods and computer program products according to various embodiments of the present technology. For instance, each block in the flowchart or block diagrams may represent a module, segment, or portion of instructions, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Some specific examples of the foregoing may have been noted above but any such noted examples are not necessarily the only such examples. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

It also will be understood that each block of the flowchart illustrations and/or block diagrams, and combinations of blocks in the flowchart illustrations and/or block diagrams, can be implemented by computer program instructions. These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer readable program instructions may also be stored in a computer readable storage medium that can direct a computer, other programmable data processing apparatus, or other devices to function in a particular manner, such that the instructions stored in the computer readable storage medium produce an article of manufacture including instructions which implement aspects of the functions/acts specified in the flowchart and/or block diagram block or blocks. The computer readable program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

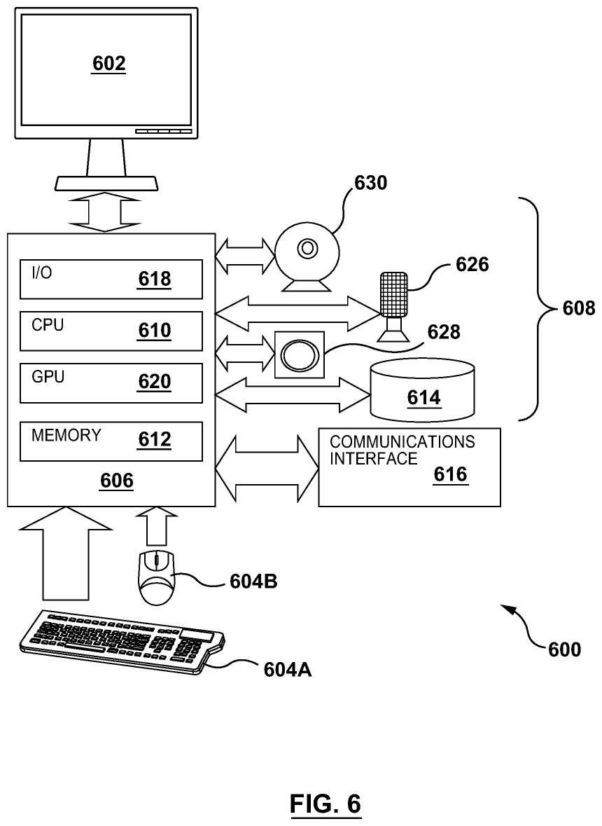

An illustrative computer system in respect of which the technology herein described may be implemented is presented as a block diagram in FIG. 6. The illustrative computer system is denoted generally by reference numeral 600 and includes a display 602, input devices in the form of keyboard 604A and pointing device 604B, computer 606 and external devices 608. While pointing device 604B is depicted as a mouse, it will be appreciated that other types of pointing device, or a touch screen, may also be used.

The computer 606 may contain one or more processors or microprocessors, such as a central processing unit (CPU) 610. The CPU 610 performs arithmetic calculations and control functions to execute software stored in an internal memory 612, preferably random access memory (RAM) and/or read only memory (ROM), and possibly additional memory 614. The additional memory 614 may include, for example, mass memory storage, hard disk drives, optical disk drives (including CD and DVD drives), magnetic disk drives, magnetic tape drives (including LTO, DLT, DAT and DCC), flash drives, program cartridges and cartridge interfaces such as those found in video game devices, removable memory chips such as EPROM or PROM, emerging storage media, such as holographic storage, or similar storage media as known in the art. This additional memory 614 may be physically internal to the computer 606, or external as shown in FIG. 6, or both.

The computer system 600 may also include other similar means for allowing computer programs or other instructions to be loaded. Such means can include, for example, a communications interface 616 which allows software and data to be transferred between the computer system 600 and external systems and networks. Examples of communications interface 616 can include a modem, a network interface such as an Ethernet card, a wireless communication interface, or a serial or parallel communications port. Software and data transferred via communications interface 616 are in the form of signals which can be electronic, acoustic, electromagnetic, optical or other signals capable of being received by communications interface 616. Multiple interfaces, of course, can be provided on a single computer system 600.

Input and output to and from the computer 606 is administered by the input/output (I/O) interface 618. This I/O interface 618 administers control of the display 602, keyboard 604A, external devices 608 and other such components of the computer system 600. The computer 606 also includes a graphical processing unit (GPU) 620. The latter may also be used for computational purposes as an adjunct to, or instead of, the CPU 610, for mathematical calculations.

The external devices 608 include a microphone 626, a speaker 628 and a camera 630. Although shown as external devices, they may alternatively be built in as part of the hardware of the computer system 600.

The various components of the computer system 600 are coupled to one another either directly or by coupling to suitable buses.

The terms “computer system”, “data processing system” and related terms, as used herein, are not limited to any particular type of computer system and encompasses servers, desktop computers, laptop computers, networked mobile wireless telecommunication computing devices such as smartphones, tablet computers, as well as other types of computer systems.

Thus, computer readable program code for implementing aspects of the technology described herein may be contained or stored in the memory 612 of the computer 606, or on a computer usable or computer readable medium external to the computer 606, or on any combination thereof.

Finally, the terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description has been presented for purposes of illustration and description, but is not intended to be exhaustive or limited to the form disclosed. Many modifications and variations will be apparent to those of ordinary skill in the art without departing from the scope of the claims. The embodiment was chosen and described in order to best explain the principles of the technology and the practical application, and to enable others of ordinary skill in the art to understand the technology for various embodiments with various modifications as are suited to the particular use contemplated.

One or more currently preferred embodiments have been described by way of example. It will be apparent to persons skilled in the art that a number of variations and modifications can be made without departing from the scope of the claims. In construing the claims, it is to be understood that the use of a computer to implement the embodiments described herein is essential.

What is claimed is:

1. A method of making cryptographic key metadata available to key owners while protecting integrity of the cryptographic key metadata, the method comprising:
extracting key metadata from a metadata storage on a key data storage system, wherein the metadata storage is logically isolated from a sensitive cryptographic data storage on the key data storage system;
transmitting, by unidirectional communication, the extracted key metadata to a user-accessible metadata database;
identifying, from the user-accessible metadata database, user-specific metadata for at least one cryptographic key associated with an authorized user associated with the at least one cryptographic key; and
communicating the identified user-specific metadata to the authorized user.

2. The method of claim 1, wherein:
identifying the user-specific metadata for the at least one cryptographic key comprises proactively identifying an impending expiry of the at least one cryptographic key; and
communicating the identified user-specific metadata to the authorized user comprises proactively communicating the impending expiry to the authorized user.

3. The method of claim 1, wherein:
identifying the metadata for the at least one cryptographic key comprises:
receiving, from a requesting user, a query against the user-accessible metadata database;
obtaining an identity of the requesting user;
testing the identity of the requesting user against access requested by the query; and
responsive to determining that the requesting user is an authorized user in respect of the access requested by the query, executing the query against the user-accessible database to obtain query results; and
communicating the identified user-specific metadata to the authorized user comprises returning the query results to the requesting user;
wherein, responsive to determining that the requesting user lacks authorization for the access requested by the query, execution of the query is declined.

4. The method of claim 1, wherein:
identifying the user-specific metadata for the at least one cryptographic key comprises proactively identifying an attestation requirement for the at least one cryptographic key; and
communicating the identified user-specific metadata to the authorized user comprises proactively communicating the attestation requirement to the authorized user.

5. The method of claim 1, further comprising:
receiving from a requesting user an update against the user-accessible metadata database;
obtaining an identity of the requesting user and testing the identity of the requesting user against access requested by the update;
responsive to determining that the requesting user is an authorized user in respect of the access requested by the update, executing the update against the user-accessible metadata database; and
responsive to determining that the requesting user lacks authorization for the access requested by the update, declining to execute the update.

6. The method of claim 5, wherein:
the update is a request to transfer key ownership of a specific cryptographic key from a current key owner to a prospective new key owner;
the requesting user is the current key owner of the specific cryptographic key; and
executing the update against the user-accessible metadata database comprises:
requesting an acceptance of the key ownership of the specific cryptographic key from the prospective new owner; and
responsive to receiving the acceptance of the key ownership of the specific cryptographic key from the prospective new owner, in the user-accessible metadata database:
delisting the requesting user as the current key owner; and
listing the prospective key owner as the current key owner.

7. A computer system comprising at least one processor and memory coupled to the at least one processor, the memory containing instructions which, when executed by the at least one processor, cause the at least one processor to implement a method of making cryptographic key metadata available to key owners while protecting integrity of the cryptographic key metadata, the method comprising:
extracting key metadata from a metadata storage on a key data storage system, wherein the metadata storage is logically isolated from a sensitive cryptographic data storage on the key data storage system;
transmitting, by unidirectional communication, the extracted key metadata to a user-accessible metadata database;
identifying, from the user-accessible metadata database, user-specific metadata for at least one cryptographic key associated with an authorized user associated with the at least one cryptographic key; and
communicating the identified user-specific metadata to the authorized user.

8. The computer system of claim 7, wherein:
identifying the user-specific metadata for the at least one cryptographic key comprises proactively identifying an impending expiry of the at least one cryptographic key; and
communicating the identified user-specific metadata to the authorized user comprises proactively communicating the impending expiry to the authorized user.

9. The computer system of claim 7, wherein:
identifying the metadata for the at least one cryptographic key comprises:
receiving, from a requesting user, a query against the user-accessible metadata database;
obtaining an identity of the requesting user;
testing the identity of the requesting user against access requested by the query; and
responsive to determining that the requesting user is an authorized user in respect of the access requested by the query, executing the query against the user-accessible database to obtain query results; and
communicating the identified user-specific metadata to the authorized user comprises returning the query results to the requesting user;
wherein, responsive to determining that the requesting user lacks authorization for the access requested by the query, execution of the query is declined.

10. The computer system of claim 7, wherein:
identifying the user-specific metadata for the at least one cryptographic key comprises proactively identifying an attestation requirement for the at least one cryptographic key; and
communicating the identified user-specific metadata to the authorized user comprises proactively communicating the attestation requirement to the authorized user.

11. The computer system of claim 7, further comprising:
receiving from a requesting user an update against the user-accessible metadata database;
obtaining an identity of the requesting user and testing the identity of the requesting user against access requested by the update;
responsive to determining that the requesting user is an authorized user in respect of the access requested by the update, executing the update against the user-accessible metadata database; and
responsive to determining that the requesting user lacks authorization for the access requested by the update, declining to execute the update.

12. The method of claim 11, wherein:
the update is a request to transfer key ownership of a specific cryptographic key from a current key owner to a prospective new key owner;
the requesting user is the current key owner of the specific cryptographic key; and
executing the update against the user-accessible metadata database comprises:
requesting an acceptance of the key ownership of the specific cryptographic key from the prospective new owner; and
responsive to receiving the acceptance of the key ownership of the specific cryptographic key from the prospective new owner, in the user-accessible metadata database:
delisting the requesting user as the current key owner; and
listing the prospective key owner as the current key owner.

13. At least one tangible, non-transitory computer-readable media containing instructions which, when executed by at least one processor of a computer system, cause the at least one processor to implement a method of making cryptographic key metadata available to key owners while protecting integrity of the cryptographic key metadata, the method comprising:
extracting key metadata from a metadata storage on a key data storage system, wherein the metadata storage is logically isolated from a sensitive cryptographic data storage on the key data storage system;
transmitting, by unidirectional communication, the extracted key metadata to a user-accessible metadata database;
identifying, from the user-accessible metadata database, user-specific metadata for at least one cryptographic key associated with an authorized user associated with the at least one cryptographic key; and
communicating the identified user-specific metadata to the authorized user.

14. The computer-readable media of claim 13, wherein:
identifying the user-specific metadata for the at least one cryptographic key comprises proactively identifying an impending expiry of the at least one cryptographic key; and
communicating the identified user-specific metadata to the authorized user comprises proactively communicating the impending expiry to the authorized user.

15. The computer-readable media of claim 13, wherein:
identifying the metadata for the at least one cryptographic key comprises:
receiving, from a requesting user, a query against the user-accessible metadata database;
obtaining an identity of the requesting user;
testing the identity of the requesting user against access requested by the query; and
responsive to determining that the requesting user is an authorized user in respect of the access requested by the query, executing the query against the user-accessible database to obtain query results; and
communicating the identified user-specific metadata to the authorized user comprises returning the query results to the requesting user;
wherein, responsive to determining that the requesting user lacks authorization for the access requested by the query, execution of the query is declined.

16. The computer-readable media of claim 13, wherein:
identifying the user-specific metadata for the at least one cryptographic key comprises proactively identifying an attestation requirement for the at least one cryptographic key; and
communicating the identified user-specific metadata to the authorized user comprises proactively communicating the attestation requirement to the authorized user.

17. The computer-readable media of claim 13, further comprising:
receiving from a requesting user an update against the user-accessible metadata database;
obtaining an identity of the requesting user and testing the identity of the requesting user against access requested by the update;
responsive to determining that the requesting user is an authorized user in respect of the access requested by the update, executing the update against the user-accessible metadata database; and
responsive to determining that the requesting user lacks authorization for the access requested by the update, declining to execute the update.

18. The computer-readable media of claim 17, wherein:
the update is a request to transfer key ownership of a specific cryptographic key from a current key owner to a prospective new key owner;
the requesting user is the current key owner of the specific cryptographic key; and
executing the update against the user-accessible metadata database comprises:
requesting an acceptance of the key ownership of the specific cryptographic key from the prospective new owner; and
responsive to receiving the acceptance of the key ownership of the specific cryptographic key from the prospective new owner, in the user-accessible metadata database:
delisting the requesting user as the current key owner; and
listing the prospective key owner as the current key owner.
